(19) United States
(12) Patent Application Publication
(10) Pub. No.: US 2016/0298853 A1
(43) Pub. Date: Oct. 13, 2016

(54) SERVICE-FRIENDLY CROSS FLAME TUBE WITH TWIST LOCK ATTACHMENT FOR CAN-ANNULAR GAS TURBINES

(71) Applicant: Siemens Energy, Inc., Orlando, FL (US)

(72) Inventors: Dustin C. Boudin, Charlotte, NC (US); Leonel R. Leon, Oviedo, FL (US)

(21) Appl. No.: 14/682,294

(22) Filed: Apr. 9, 2015

(51) Int. Cl. F23R 3/48; F16L 23/00; F16L 37/24; F23R 3/60; F02C 3/14

(52) U.S. Cl. CPC F23R 3/48; F23R 3/60; F02C 3/14; F16L 37/24; F16L 23/00

(57) ABSTRACT

A twist lock attachment mechanism for attaching a cross flame tube to a cross flame tube port that is part of a combustor basket in a combustion section of a gas turbine engine, where the cross flame tube includes opposing flange sections coupled to an end of the cross flame tube and being spaced apart from each other. The attachment mechanism includes an annular collar mounted to the cross flame tube port and first and second spaced apart flange extensions mounted to the annular collar, where each flange extension includes a slot open at one end and blocked at an opposite end. The flange sections of the cross flame tube are positioned between the flange extensions so that the flange sections align with the slots, and the cross flame tube is rotated in a manner that causes the flange sections to slide into the slots.

### BACKGROUND OF THE INVENTION

1. Field of the Invention

This invention relates generally to a twist lock attachment mechanism for coupling a cross flame tube to a combustor basket in a gas turbine engine and, more particularly, to a twist lock attachment mechanism for coupling a cross flame tube to a combustor basket in a combustor section of a gas turbine engine, where the attachment mechanism includes opposing flange extensions each having a slot that accepts a flange section on the cross flame tube.

2. Discussion of the Related Art

The world's energy needs continue to rise which provides a demand for reliable, affordable, efficient and environmentally-compatible power generation. A gas turbine engine is one known machine that provides efficient power, and often has application for an electric generator in a power plant, or engines in an aircraft or a ship. A typically gas turbine engine includes a compressor section, a combustion section and a turbine section. The compressor section provides a compressed airflow to the combustion section, where the air is mixed with a fuel, such as natural gas. The combustion section includes a plurality of circumferentially disposed combustors that receive the fuel to be mixed with the air and ignited to generate a working gas. The working gas expands through the turbine section and is directed across rows of blades therein by associated vanes. As the working gas passes through the turbine section, it causes the blades to rotate, which in turn causes a shaft to rotate, thereby providing mechanical work.

In one known gas turbine engine design, a single igniter is used to ignite several of the combustors that are circumferentially disposed around the engine. In these types of designs, a cross flame tube is generally coupled to adjacent combustor baskets associated with each combustor, where the fuel and air are mixed together in the combustor basket and ignited to generate the hot working gas. The ignition flame from the igniter travels from combustor basket to combustor basket through the cross flame tubes to ignite the gas therein, thus reducing the number of igniters required for a particular engine. In one particular design of this type, a Marman clamp, well known to those skilled in the art, is used to couple the cross flame tube to a cross flame tube port extending from the combustor basket.

Gas turbine engines of the type referred to above require periodic maintenance, where the engine is usually disassembled and cleaned, and where burned or failing parts are replaced. Current field inspection and maintenance procedures for disassembly and assembly of a gas turbine engine take a significant amount of time and man power to complete. In the gas turbine engine design referred to above that includes cross flame tubes, the combustion system cannot be taken out of the engine in one piece. Disassembly of the combustion section requires that the cross flame tubes be disconnected from the combustors by disconnecting the Marman clamp to release the cross flame tube from the cross flame tube ports. However, the Marman clamp cannot be easily removed internal to the combustor shell. Therefore, this design for these types of engines requires additional maintenance steps adding time and cost that can be improved upon.

### SUMMARY OF THE INVENTION

The present disclosure describes a twist lock attachment mechanism for attaching a cross flame tube to a cross flame tube port that is part of a combustor basket in a combustion section of a gas turbine engine, where the cross flame tube includes opposing flange sections coupled to an end of the cross flame tube and being spaced apart from each other. The attachment mechanism includes an annular collar mounted to the cross flame tube port and first and second spaced apart flange extensions mounted to the annular collar, where each flange extension includes a slot open at one end and blocked at an opposite end. The flange sections on the cross flame tube are positioned between the flange extensions so that the flange sections align with the slots, and the cross flame tube is rotated in a manner that causes the flange sections to slide into the slots and secure the cross flame tube to the cross flame tube port. Pins are then employed to prevent the cross flame tube from rotating out of the slots.

Additional features of the present invention will become apparent from the following description and appended claims, taken in conjunction with the accompanying drawings.

### BRIEF DESCRIPTION OF THE DRAWINGS

FIG. 1 is a cut-away, isometric view of a gas turbine engine;

FIG. 2 is a front view of a combustor section of the gas turbine engine shown in FIG. 1;

FIG. 3 is an isometric view of a cross flame tube being coupled to a cross flame tube port on a combustor basket by a Marman clamp within the combustion section of the gas turbine engine;

FIG. 4 is a front view of the Marman clamp used to attach a cross flame tube to a cross flame tube port;

FIG. 5 is an isometric view of the cross flame tube and the cross flame tube port without the Marman clamp;

FIG. 6 is an isometric view of two combustor baskets and a cross flame tube extending therebetween, where the cross flame tube is coupled at each end to a cross flame tube port by a twist lock attachment mechanism;

FIG. 7 is an enlarged view of the cross flame tube shown in FIG. 6 connected to the cross flame tube ports; and

FIG. 8 is an enlarged view of one end of the cross flame tube shown in FIG. 6 being detached from the twist lock attachment mechanism.

### DETAILED DESCRIPTION OF THE EMBODIMENTS

The following discussion of the embodiments of the invention directed to a twist lock attachment mechanism for coupling a cross flame tube to a cross flame tube port on a combustor basket in a combustor section of a gas turbine engine is merely exemplary in nature, and is in no way intended to limit the invention or its applications or uses.

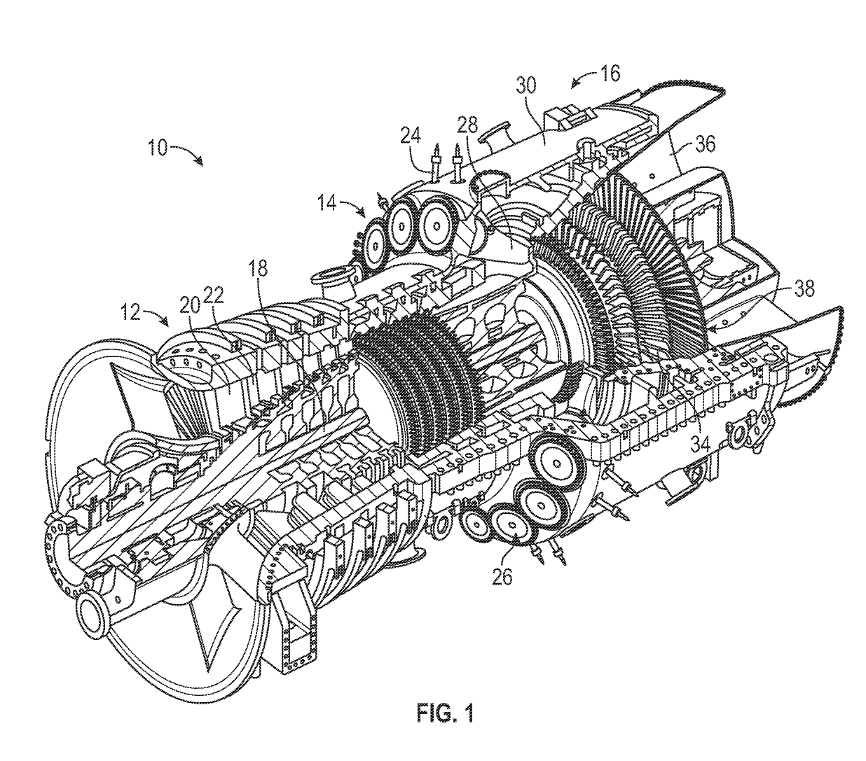

FIG. 1 is a cut-away, isometric view of a gas turbine engine 10 including a compressor section 12, a combustion section 14 and a turbine section 16 all enclosed within an outer housing or casing 30, where operation of the engine 10 causes a central shaft or rotor 18 to rotate, thus creating mechanical work. The engine 10 is illustrated and described by way of a non-limiting example to provide context to the invention discussed below. Those skilled in the art will appreciate that other gas turbine engine designs can also be used in connection with the invention. Rotation of the rotor 18 draws air into the compressor section 12 where it is directed by vanes 22 and compressed by rotating blades 20 to be delivered to the combustion section 14, where the compressed air is mixed with a fuel, such as natural gas, and where the fuel/air mixture is ignited to create a hot working gas. More specifically, the combustion section 14 includes a number of circumferentially disposed combustors 26 each receiving the fuel that is injected into the combustor 26 by an injector (not shown), mixed with the compressed air and ignited by an igniter 24 to be combusted to create the working gas, which is directed by a transition component 28 into the turbine section 16. The working gas is then directed by circumferentially disposed stationary vanes (not shown in FIG. 1) in the turbine section 16 to flow across circumferentially disposed rotatable turbine blades 34, which causes the turbine blades 34 to rotate, thus rotating the rotor 18. Once the working gas passes through the turbine section 16 it is output from the engine 10 as an exhaust gas through an output nozzle 36.

Each group of the circumferentially disposed stationary vanes defines a row of the vanes and each group of the circumferentially disposed blades 34 defines a row 38 of the blades 34. In this non-limiting embodiment, the turbine section 16 includes four rows 38 of the rotating blades 34 and four rows of the stationary vanes in an alternating sequence. In other gas turbine engine designs, the turbine section 16 may include more or less rows of the turbine blades 34. It is noted that the most forward row of the turbine blades 34, referred to as the row 1 blades, and the vanes, referred to as the row 1 vanes, receive the highest temperature of the working gas, where the temperature of the working gas decreases as it flows through the turbine section 16.

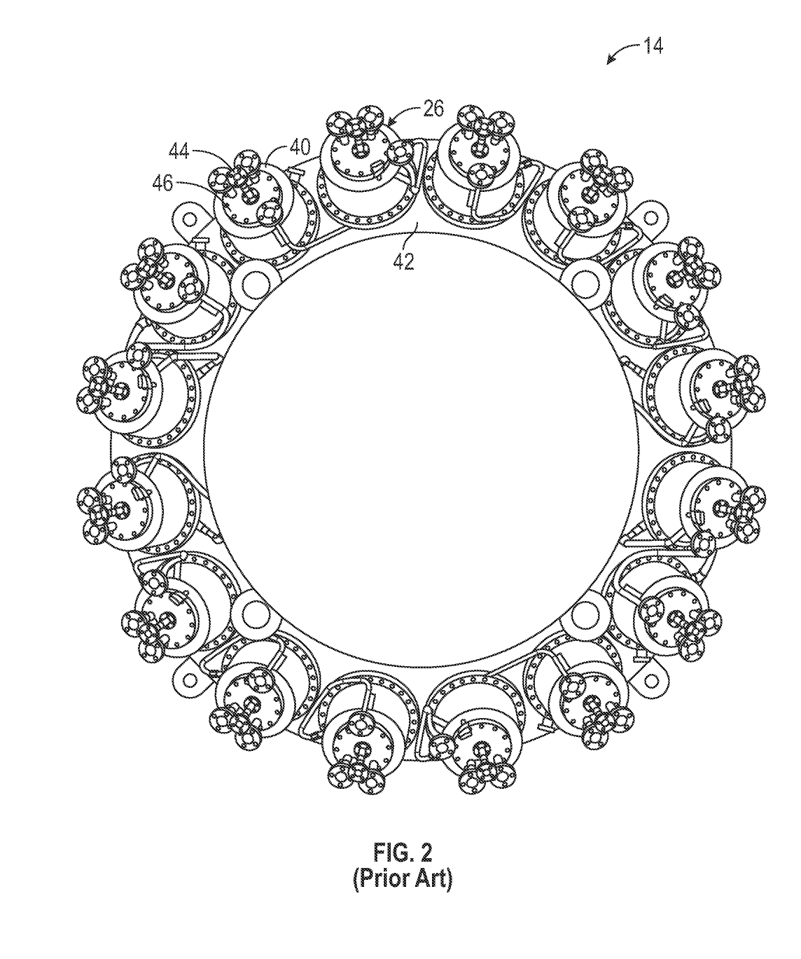

FIG. 2 is a front view of the combustion section 14 shown separated from the gas turbine engine 10 and including sixteen of the combustors 26 as a non-limiting example. Each combustor 26 includes a top hat portion 40 bolted to one side of an outer casing 42 that is part of the housing 30 and has a significant thickness in a direction into the paper. The combustors 26 also include a pilot nozzle 44 that is bolted to a support housing 46, which is bolted to the top hat portion 40. A combustor basket (not shown in FIG. 2) in which the combustion occurs in the combustor 26, in a manner well understood by those skilled in the art, is inserted into the top hat portion 40 through a suitably configured opening in the casing 42 and is secured to the casing 42.

FIG. 3 is cut-away isometric view of a portion of the combustion section 14 illustrating a cut-away portion of a combustor basket 50 positioned within an opening 48 in the casing 42 and extending into the top hot portion 40 for one of the combustors 26. A cylindrical cross flame tube 52 extends through a channel 54 formed in the casing 42 and is coupled at one end to a cross flame tube port 56 on the combustor basket 50 by a known Marman clamp 58. An opposite end of the cross flame tube 52 is coupled to a cross flame tube port (not shown) of an adjacent combustor basket (not shown) associated with a different combustor 26.

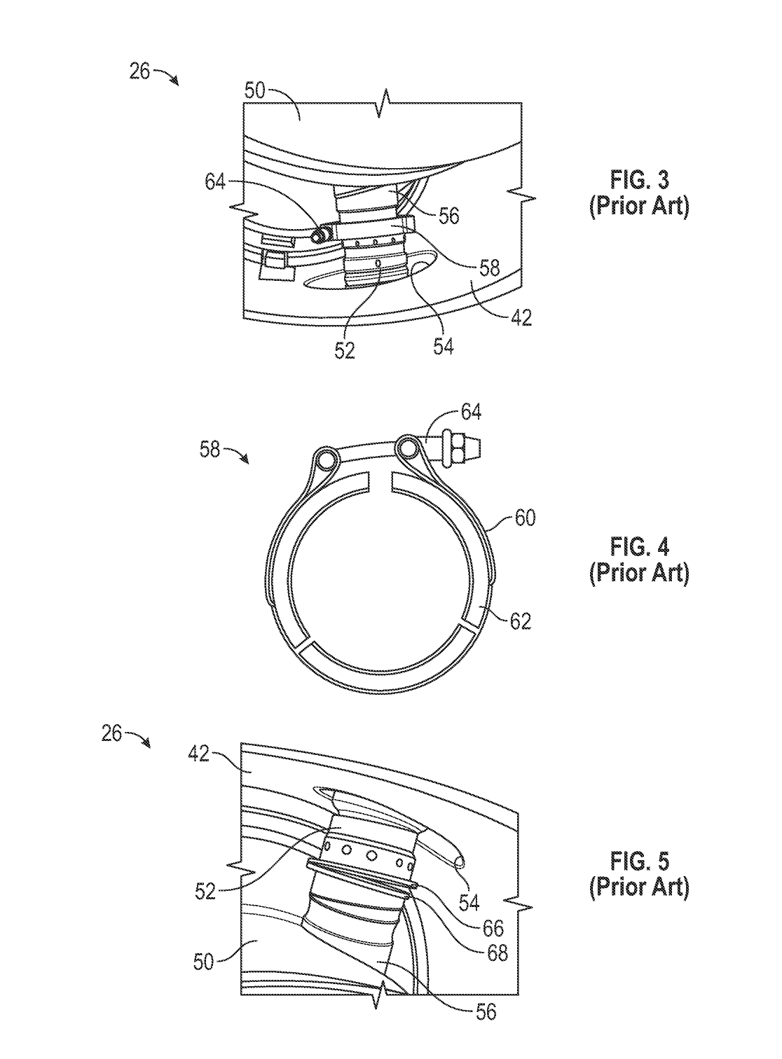

FIG. 4 is a front view of the Marman clamp 58 separated from the cross flame tube 56, where the clamp 58 includes an outer band 60, a cushion insert 62 and a securing bolt 64. The bolt 64 is coupled to the outer band 60 so that when the bolt 64 is tightened, the circumference of the band 60 is reduced to tighten the clamp 58 in a manner that is well understood by those skilled in the art.

FIG. 5 is a cut-away isometric view of the combustion section 14 similar to the view shown in FIG. 3 with the clamp 58 removed, where the orientation of the view is reversed from that shown in FIG. 3. The cross flame tube 52 includes an annular end flange 66 and the cross flame tube port 56 includes an annular end flange 68. When the cross flame tube 52 is coupled to the cross flame tube port 56, the flanges 66 and 68 are aligned, and the Marman clamp 58 is slid over the flanges 66 and 68 and tightened using the bolt 64 to secure the cross flame tube 52 to the port 56 in a manner well understood by those skilled in the art.

As discussed above, during disassembly of the combustion section 14 for maintenance and inspection purposes, it is necessary to disconnect each of the cross flame tubes from their associated combustor baskets to effectively remove the parts to be inspected from the combustion section 14. In this design, it is difficult to remove the Marman clamps on the side of the casing 42 including the top hat portions 40 if it turns on the cross flame tube 50 during operation leading to cutting of the cross flame tube 50. This results in an extended combustion inspection outage time and delays. Also, it is somewhat difficult and time consuming to align the flanges 66 and 68, position the clamp 58 and tighten the bolt 64 during reassembly of the combustion section 14 especially in view of the number of clamps that are typically associated with a particular engine.

As will be discussed in detail below, the present invention proposes reconfiguring the cross flame tubes in the combustion section of a gas turbine engine of this type so that the cross flame tubes can be easily disconnected from the cross flame tube port on the combustor basket, and then be easily reattached to the cross flame tube port during reassembly. In the particular design discussed in detail below, the flange 66 is redesigned and a twist lock attachment mechanism is employed to connect the cross flame tube to the cross flame tube port, where the cross flame tube is rotated within slots in locking flanges to couple it to the cross flame tube ports.

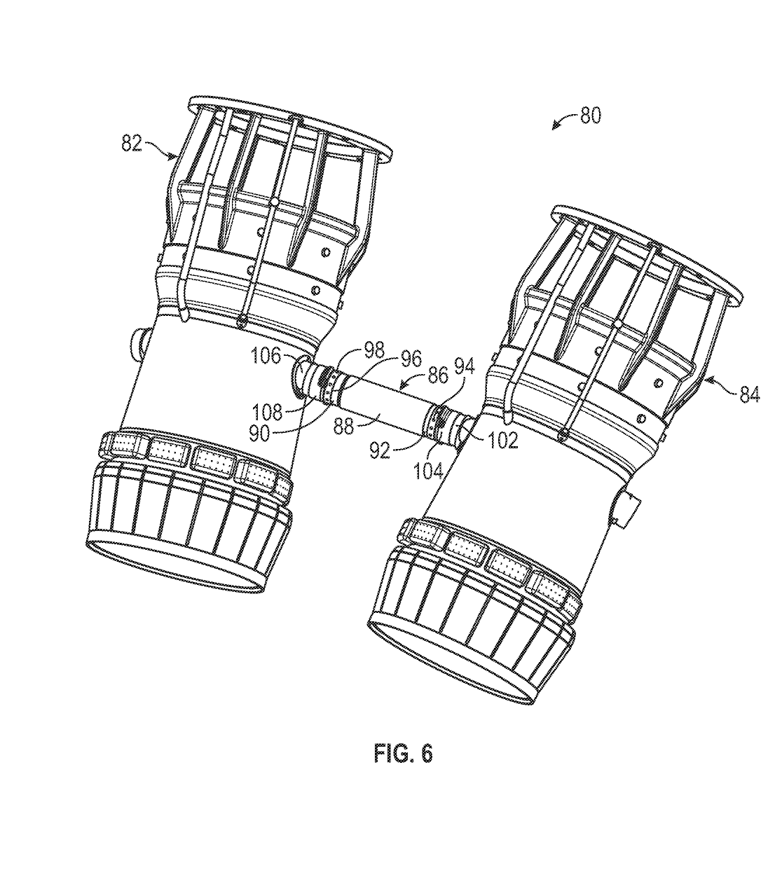

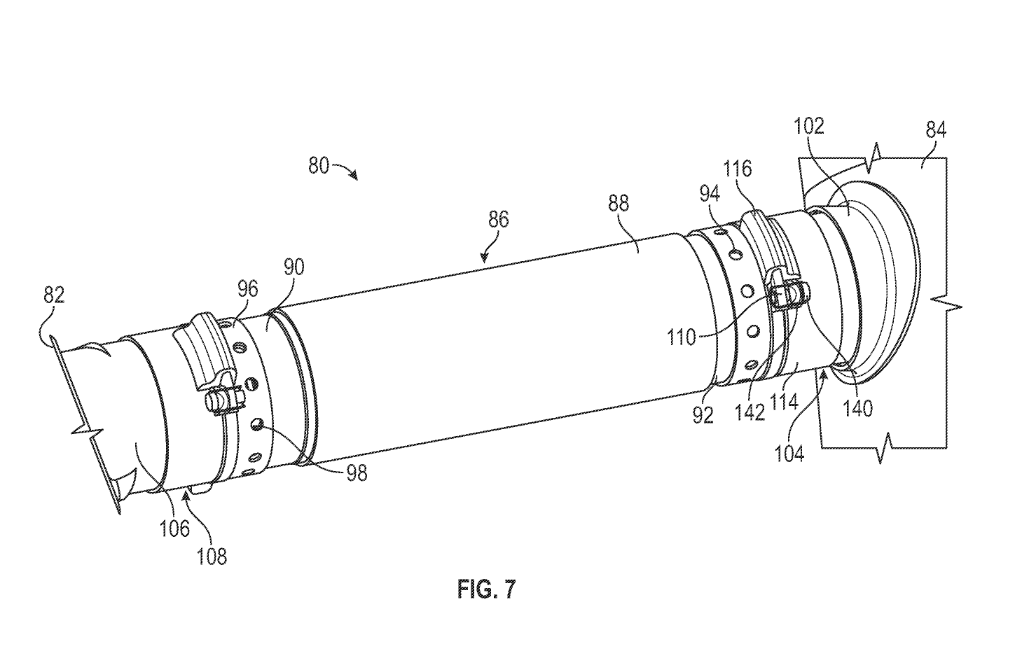

FIG. 6 is an isometric view of a portion of a combustion section 80 of a gas turbine engine of the type generally discussed above showing two adjacent combustor baskets 82 and 84 that would each be part of adjacent combustors in the combustion section 80. The combustor baskets 82 and 84 are coupled to a cylindrical cross flame tube 86 of the type discussed above, where an enlarged view of the cross flame tube 86 coupled to the combustor baskets 82 and 84 is shown in FIG. 7. The cross flame tube 86 includes a longer section 88 and a shorter section 90, where a portion of the shorter section 90 is slid into the longer section 88, and where the sections 88 and 90 are rotatable relative to each other. An end portion 92 of the section 88 at an end opposite to the section 90 includes a series of circumferentially disposed ports 94 that are open to the internal chamber within the cross flame tube 86 and allow air to enter the cross flame tube 86. Likewise, an end portion 96 of the section 90 at an end opposite to the section 88 includes a series of circumferentially disposed ports 98 that are open to the internal chamber within the cross flame tube 86. As will be discussed in detail below, the section 88 of the cross flame tube 86 is coupled to a cross flame tube port 102 associated with the combustor basket 84 by a twist lock attachment mechanism 104 and the section 90 of the cross flame tube 86 is coupled to a cross flame tube port 106 associated with the combustor basket 82 by a twist lock attachment mechanism 108.

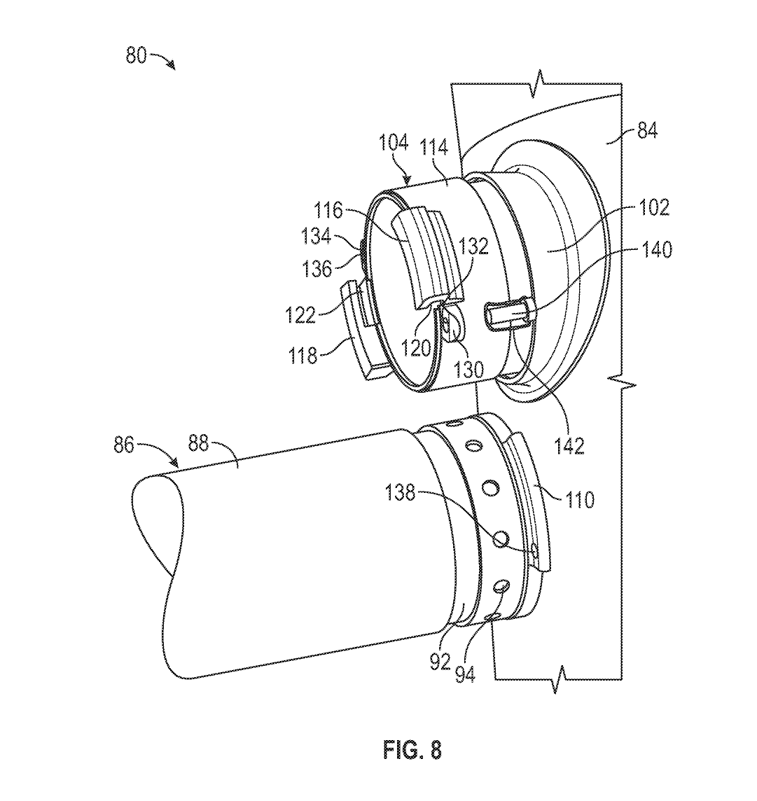

FIG. 8 is an exploded, broken-away, isometric view of the combustion section 80 showing the section 88 of the cross flame tube 86 being detached from the twist lock attachment mechanism 104, and thus being detached from the cross flame tube port 102. The discussion herein of how the cross flame tube 86 is attached and detached to and from the port 102 equally applies to the section 90 of the cross flame tube 86 being attached and detached to the port 106 by the twist lock attachment mechanism 108. For this design, the flange 66 referred to above has been reconfigured to include two opposing flange sections 110, where only one of the flange sections 110 is shown in FIG. 8 and where the remaining portion of the flange 66 has been removed.

The attachment mechanism 104 includes an annular collar 114 that is rigidly secured to the port 102 by welding or the like. The attachment mechanism 104 also includes spaced apart and opposing flange extensions 116 and 118 positioned on opposite sides of the collar 114 each including a slot 120 and 122, respectively, where each slot 120 and 122 is open at one end and closed at an opposite end, as shown. The attachment mechanism 104 also includes a tab 130 positioned proximate to the open end of the slot 120 and extending radially from the collar 114, where the tab 130 includes an opening 132. Likewise, the attachment mechanism 104 includes a tab 134 positioned proximate to the open end of the slot 122 and extending radially from the collar 114, where the tab 134 includes an opening 136. Further, the flange sections 110 each include an opening 138. As is apparent, the flange sections 110 and the flange extensions 116 and 118 are generally curved to follow the curvature of the end of the section 88. In one non-limiting embodiment, the flange sections 110 and the flange extensions 116 and 118 have a radius of curvature of about 30°.

When the cross flame tube 86 is coupled to the port 102, the section 88 is rotated so that each of the flange sections 110 is positioned between opposing ends of the flange extensions 116 and 118 and the flange sections 110 are aligned with the slots 120 and 122. The section 88 of the cross flame tube 86 is then rotated so that one of the flange sections 110 slides into the slot 120 and the other flange section 110 slides into the slot 122 so that the cross flame tube 86 is rigidly held to the attachment mechanism 104. The section 88 of the cross flame tube 86 is rotated to a degree so that the flange sections 110 slide in the separate slots 120 and 122 and the opening 138 in one of the flange sections 110 is aligned with the opening 132 in the tab 130 and the opening 138 in the other flange section 110 is aligned with the opening 136 in the tab 134. A cylindrical pin 140 is slid through the openings 132 and 138 to lock the cross flame tube 86 to the port 96 and prevent rotation. Likewise, an opposing cylindrical pin (not shown) is slid within the openings 132 and 136. A bale 142 pivotally mounted to the pin 140 is provided in an open position while the pin 140 is being slid into the openings 132 and 138, and is closed around the tab 130 and the flange section 110 to lock the pin 140 to the cross flame tube 86. The other pin also includes a suitably configured bale to hold the pin the in openings.

When it is time to disconnect the cross flame tube 86 from the cross flame tube port 102, the pins are removed from the openings and the section 88 is rotated to slide the flange sections 110 out of the slots 120 and 122. In this manner, the cross flame tube 86 can be easily attached to and detached from the ports 102 and 106. Also, this allows the top hat portion 40 to be unbolted from the casing 42 and the entire combustor 26 to be removed as a single unit from the combustion section 14.

The foregoing discussion discloses and describes merely exemplary embodiments of the present invention. One skilled in the art will readily recognize from such discussion, and from the accompanying drawings and claims, that various changes, modifications and variations can be made therein without departing from the scope of the invention as defined in the following claims.

What is claimed is:

1. A twist lock attachment mechanism for attaching a cross flame tube to a cross flame tube port that is part of a combustor basket in a combustion section of a gas turbine engine, said cross flame tube including opposing annular flange sections formed to an end of the cross flame tube and being spaced apart from each other, said attachment mechanism comprising:
an annular collar mounted to the cross flame tube port; and
first and second spaced apart flange extensions mounted to the annular collar where each flange extension includes a slot that is open at one end and blocked at an opposite end, wherein the flange sections of the cross flame tube are positioned between the flange extensions so that each flange section aligns with one of the slots, and wherein the cross flame tube is rotated in a manner that causes the flange sections to slide into the slots and secure the cross flame tube to the cross flame tube port.

2. The attachment mechanism according to claim 1 further comprising a pair of tabs extending radially from the annular collar where a first one of the tabs is positioned adjacent to the open end of the slot in the first flange extension and a second tab is positioned adjacent to the open end of the slot in the second flange extension, said first and second tabs each including an opening that aligns with an opening in the flange section on the cross flame tube when the flange sections are positioned within the slots.

3. The attachment mechanism according to claim 2 further comprising a pair of cylindrical pins where a first pin is slid into the opening in the first tab and the opening in the first flange section and the second pin is slid into the opening in the second tab and the opening in the second flange extension so as to lock the cross flame tube to the cross flame tube port.

4. The attachment mechanism according to claim 2 wherein each pin includes a pivotable bale that when opened allows the pin to be inserted into the openings and when closed holds the pin to the cross flame tube.

5. The attachment mechanism according to claim 1 wherein the cross flame tube includes a first cylindrical section and a second cylindrical section, where the first cylindrical section is inserted into the second cylindrical section and is rotatable relative thereto, and wherein a twist lock attachment mechanism is provided for attaching opposite ends of the cross flame tube to adjacent combustor baskets.

6. A pair of twist lock attachment mechanisms for attaching a cross flame tube to cross flame tube ports on adjacent combustor baskets in a combustion section of a gas turbine engine, said cross flame tube including a first cylindrical section and a second cylindrical section where the first cylindrical section is inserted into the second cylindrical section and is rotatable relative thereto, each end of the cross flame tube including opposing annular flange sections formed to an end of the cross flame tube and being spaced apart from each other, each attachment mechanism comprising:
an annular collar mounted to the cross flame tube port of the associated combustor basket; and
first and second spaced apart flange extensions mounted to the annular collar where each flange extension includes a slot that is open at one end and blocked at an opposite end, wherein the flange sections of the cross flame tube are positioned between the flange extensions so that each flange section aligns with one of the slots, and wherein the particular section of the cross flame tube is rotated in a manner that causes the flange sections to slide into the slots and secure the cross flame tube to the cross flame tube port.

7. The attachment mechanisms according to claim 6 each further comprising a pair of tabs extending radially from the annular collar where a first one of the tabs is positioned adjacent to the open end of the slot in the first flange extension and a second tab is positioned adjacent to the open end of the slot in the second flange extension, said first and second tabs each including an opening that aligns with an opening in the flange section on the cross flame tube when the flange sections are positioned within the slots.

8. The attachment mechanisms according to claim 7 further comprising a pair of cylindrical pins where a first pin is slid into the opening in the first tab and the opening in the first flange section and the second pin is slid into the opening in the second tab and the opening in the second flange extension so as to lock the cross flame tube to the cross flame tube port.

9. The attachment mechanisms according to claim 8 wherein each pin includes a pivotable bale that when opened allows the pin to be inserted into the openings and when closed holds the pin to the cross flame tube.

10. A gas turbine engine comprising:
a rotatable shaft provided along a center line of the turbine;
a compressor section responsive to a working fluid and being operable to compress the working fluid to produce a compressed working fluid;
a combustion section in fluid communication with the compressor section that receives the compressed working fluid, said combustion section including a plurality of combustors that mix the compressed working fluid with a fuel and combust the compressed fluid and fuel mixture to produce a hot working fluid, each combustor including a combustor basket in which the combustion occurs, each combustor basket including a cross flame tube port, said combustion section including a plurality of cross flame tubes that couple adjacent combustor baskets, said cross flame tubes each including opposing annular flange sections formed to an end of the cross flame tube and being spaced apart from each other, each end of the cross flame tube including a twist lock attachment mechanism having an annular collar mounted to the cross flame tube port and first and second spaced apart flange extensions mounted to the annular collar where each flange extension includes a slot that is opened at one end and blocked at an opposite end, wherein the flange sections of the cross flame tube are positioned between the flange extensions so that each flange section aligns with one of the slots, and wherein the cross flame tube is rotated in a manner that causes the flange sections to slide into the slots and secure the cross flame tube to the cross flame tube port; and
a turbine section in fluid communication with the combustion section, said turbine section expanding the hot working fluid to produce mechanical power through rotation of the shaft.

11. The gas turbine engine according to claim 10 wherein the attachment mechanism further includes a pair of tabs extending radially from the annular collar where a first one of the tabs is positioned adjacent to the open end of the slot in the first flange extension and a second tab is positioned adjacent to the open end of the slot in the second flange extension, said first and second tabs each including an opening that aligns with an opening in the flange section on the cross flame tube when the flange sections are positioned within the slots.

12. The gas turbine engine according to claim 11 wherein the attachment mechanism further includes a pair of cylindrical pins where a first pin is slid into the opening in the first tab and the opening in the first flange section and the second pin is slid into the opening in the second tab and the opening in the second flange extension so as to lock the cross flame tube to the cross flame tube port.

13. The gas turbine engine according to claim 11 wherein each pin includes a pivotable bale that when opened allows the pin to be inserted into the openings and when closed holds the pin to the cross flame tube.

14. The gas turbine engine according to claim 10 wherein the cross flame tube includes a first cylindrical section and a second cylindrical section, where the first cylindrical section is inserted into the second cylindrical section and is rotatable relative thereto.
